(19) United States
(12) Patent Application Publication
(10) Pub. No.: US 2025/0139565 A1
(43) Pub. Date: May 1, 2025

(54) Periodic Vertiport Usage and Capacity Data Exchange

(71) Applicant: Joby Aero, Inc., Santa Cruz, CA (US)

(72) Inventors: Eric Mueller, San Francisco, CA (US); Christabelle osson, Mountain View, CA (US); Ian Andreas Villa, San Francisco, CA (US); Adam Shaw Warmoth, Los Angeles, CA (US)

(21) Appl. No.: 19/003,914

(22) Filed: Dec. 27, 2024

Related U.S. Application Data
(63) Continuation of application No. 17/303,472, filed on May 28, 2021.
(60) Provisional application No. 63/031,219, filed on May 28, 2020.

(51) Int. Cl. G06Q 10/067; B64C 19/00; G01C 21/20; G06N 20/00; G06Q 10/02; G06Q 10/047; G06Q 10/0631; G06Q 30/08; G06Q 50/40

(52) U.S. Cl. CPC G06Q 10/067; B64C 19/00; G01C 21/20; G06N 20/00; G06Q 10/02; G06Q 10/047; G06Q 10/06312; G06Q 10/06313; G06Q 10/06315; G06Q 50/40; G06Q 30/08

(57) ABSTRACT

Example embodiments are directed to providing periodic vertiport usage and capacity data exchange. A cloud service system generates, based on historical data, a flight operation set that comprises a simulation of flight operations for time buckets in the future, where the simulation of flight operations include transportation services between vertiports. The system then receives, within a predetermined time period of the time buckets, real-time data including weather forecasts and actual demand for transportation services. The real-time data is analyzed to determine any deviations from the flight operation set for the time buckets. The system then presents the flight operation set including any deviations. Additionally, the system receives, after the time buckets has passed, real-time data indicating actual flight operations, compares the real-time data to the flight operation set to identify deltas, and provides the deltas as feedback to refine the generating of future flight operation sets.

### RELATED APPLICATIONS

The subject application is a continuation application of, U.S. Non-Provisional patent application Ser. No. 17/303,472, filed May 28, 2021, which claims the benefit of priority to U.S. Provisional Application No. 63/031,219, filed May 28, 2020. The subject application claims the benefit of priority to all such applications and all such applications are incorporated by reference herein in their entirety for all purposes.

### TECHNICAL FIELD

The subject matter disclosed herein generally relates to special-purpose machines configured for determining vertiport usage, and to the technologies by which such special-purpose machines become improved compared to other machines that determine usage of facilities. Specifically, the present disclosure addresses systems and methods that optimizes periodic vertiport usage and exchange vertiport availability data with other flight networks.

### BACKGROUND

Skyports are aerial vehicle hubs having multiple takeoff and landing facilities. One type of skyport is a vertiport which is a VTOL (vertical takeoff and landing) hub having multiple takeoff and landing pads. Each skyport can be associated with a public or private entity and different entities can make arrangements to use each other's available facilities.

### BRIEF DESCRIPTION OF THE DRAWINGS

Some embodiments are illustrated by way of example and not limitation in the figures of the accompanying drawings.

FIG. 1 is a diagram illustrating a network environment suitable for optimizing periodic vertiport usage and exchanging vertiport availability data, according to some example embodiments.

FIG. 2 is a block diagram illustrating components of a cloud service system, according to some example embodiments.

FIG. 3 is a flowchart illustrating operations of a method for simulating flight operations, according to some example embodiments.

FIG. 4 is a flowchart illustrating operations of a method for optimizing vertiport usage for transportation services, according to some example embodiments.

FIG. 5 is a flowchart illustrating operations of a further method for optimizing vertiport usage for transportation services, according to some example embodiments.

FIG. 6 is a flowchart illustrating operations of a method for determining and exchanging availability data, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present disclosure provides technical solutions for optimizing periodic vertiport usage and exchanging vertiport availability data. In example embodiments, a ground-based cloud service system is communicatively linked via a network to a plurality of data sources and other flight networks. The cloud service system receives real-time information from the plurality of data sources and accesses historical data. The historical data can be used to simulate flight operations, effectively generating a set of flight operations that can be used to schedule flight operations in advance. As the scheduled time approaches, real-time data, such as weather forecasts, known airspace conditions, and transportation requests, is received. The real-time data is analyzed to determine actual vertiport availability and capacity including actual flight option(s) for transportation service requests. Differences between the actual flight operations and the simulation are determined and the difference can be applied back to the simulation to refine the set of flight operations over time. In some embodiments, the set of flight operations may indicate opportunity costs that are used to determine whether to offer vertiport availability (also referred to as “vertiport capacity”) to other flight networks (e.g., third-party entities) or to request availability from other flight networks.

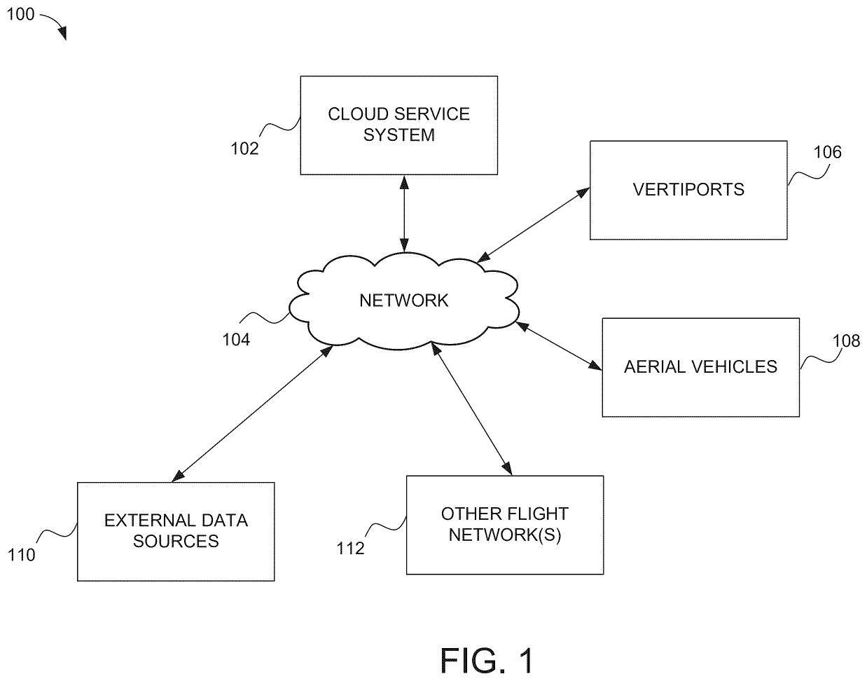

FIG. 1 is a diagram illustrating a network environment 100 suitable for optimizing periodic vertiport usage and exchanging vertiport availability data, in accordance with example embodiments. The network environment 100 includes a cloud service system 102 communicatively coupled via a network 104 to a plurality of data sources. The plurality of data sources includes a plurality of vertiports 106 under the direct control of the cloud service system 102 (also referred to as “first party vertiports”) and aerial vehicles 108 under the control of the cloud service system 102 (also referred to as “first party vehicles”). The plurality of vertiports 106 each continuously provides their status to the cloud service system 102. Status can include one or more of pads currently or soon to be used for takeoffs or landings, pads used for maintenance of an aerial vehicle, pads used for charging, and whether the vertiport is offline (e.g., closed to flights) or online (e.g., open and available for flights), what voice communication frequencies are in use, which traffic patterns are applicable, or how many passengers will be using the vertiport. In one embodiment, a vertiport can be temporarily placed online for an event or, vice-versa, taken offline for an event that closes airspace around the vertiport. In a further embodiment, pads at each vertiport can be identified as being offline (e.g., under maintenance or not in use) or online (e.g., operational).

The aerial vehicles 108 each continuously provides flight data to the cloud service system 102 in real time (e.g., in-flight). The flight data includes telemetry data and vehicle data from the avionics and/or pilot. The vehicle data can include, for example, energy levels (e.g., fuel status), heading, speed, and airspace systems statuses (e.g., is a component malfunctioning). The flight data can be used to estimate when the aerial vehicles will need access to pads at particular vertiports and how much “charging” will be needed. Thus, the aerial vehicles provide real-time data to the cloud service system 102 that can affect the vertiport capacity. For example, if an aerial vehicle has a malfunctioning component or will require a longer refueling time, the pad on which the aerial vehicle is on will be unavailable for use for some time thus, lowering capacity at the vertiport.

In example embodiments, a user (e.g., a requester of a transportation service) operates a device (not shown) that executes a client application to request transportation service from an origin to a destination. The request is communicated to the cloud service system 102, which uses the origin, destination, and passenger information to determine an optimal flight plan or options. The optimal flight plan includes a selection of the vertiports to use for the transportation service along with an available aerial vehicle. In example embodiments, the aerial vehicle 108 (e.g., helicopter, airplane) provides the transportation service to the user. The transportation service includes transporting passengers, cargo, or a combination of both

The data sources further include a plurality of external data sources 110 that are external to the control of the cloud service system 102. The external data sources 110 include sources that provides data on temporary flight restrictions (TFRs), air traffic configurations and reconfigurations, real-time weather, tracking of third-party aerial vehicles, energy pricing and capacity, and emergency medical services (EMS) requests.

In example embodiments, the cloud service system 102 manages the vertiports 106 and aerial vehicles 108 under its control. For example, the cloud service system 102 generates flight operations for the aerial vehicles 108, monitors the aerial vehicles 108 before, during, and after a flight, and revises the flight operations for deviations. In a further example, the cloud service system 102 may assign aerial vehicles 108 for transportation services and indicate which pads at which vertiports 106 (or vertiports of other flight networks 112) to use for takeoff and landing.

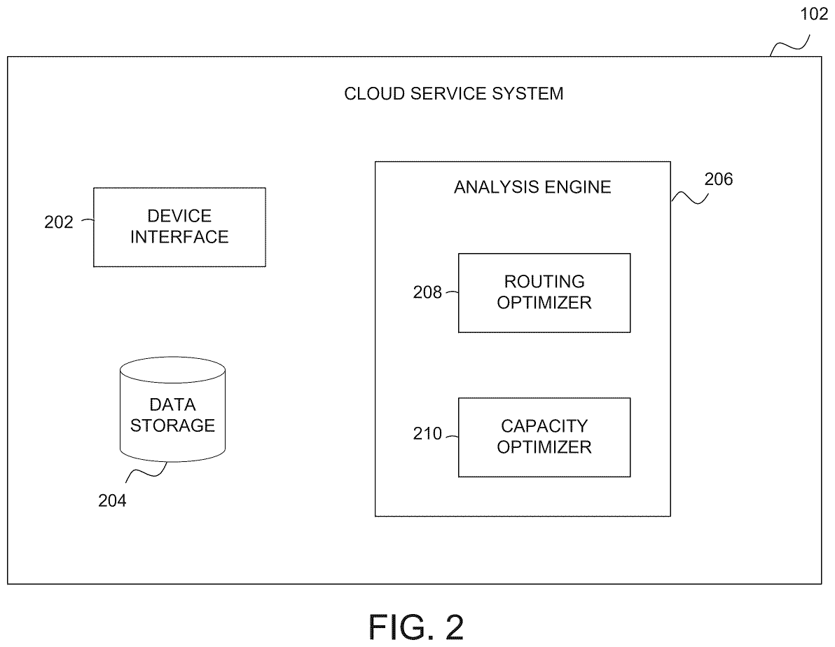

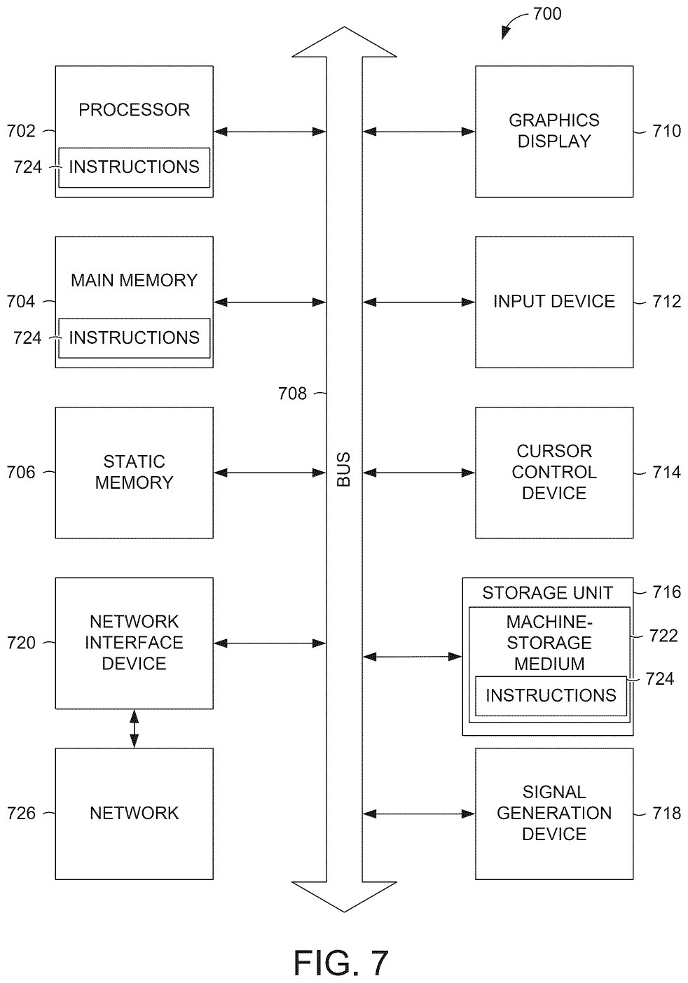

Additionally, the cloud service system 102 comprises components that obtain, store, and analyze data from the various data sources along with historical data to determine which vertiports to use for the transportation services, which first-party vertiports 106 to make available to other flight networks 112, and whether the cloud service system 102 may need additional capacity from other flight networks 112. As such, the cloud service system 102 continuously receives real-time data from a plurality of sources. Based on the real-time data, the cloud service system 102 continuously revises predicted flight operations and vertiport availability (e.g., flight operations that could have been developed weeks or months in advance) as the schedule of the flight operations approaches. The sheer amount of data that is received and analyzed on a continual basis exceeds the capability of any human operators. Further still, any deltas or deviations between the predicted flight operation and the revised version is fed back to the component of the cloud service system 102 to train the component and refine further predicted flight operations and vertiport availability. The components of the cloud service system 102 are described in more detail in connection with FIG. 2 and may be implemented in a computer system, as described below with respect to FIG. 7.

The other flight networks 112 are third-party entities that control third-party vertiports. In example embodiments, the cloud service system 102 may offer pads at the first-party vertiports 106 to the other flight networks 112 for use and vice-versa. The determination as to whether to offer first-party vertiport availability to the other flight networks 112 or to use an available pad at a vertiport of the other flight networks 112 is based on projected demand and opportunity costs derived by the cloud service system 102 based on simulations and real-time data as will be discussed in more detail below.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, any of the systems, machines, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined into a component, and the functions described herein for any single component may be subdivided among multiple component. Additionally, any number of aerial vehicles 106 may be embodied within the network environment 100. Furthermore, some components or functions of the network environment 100 may be combined or located elsewhere in the network environment 100. While only a single cloud service system 102 is shown, alternative embodiments may contemplate having more than one cloud service system 102 to perform operations discussed herein (e.g., based on regions).

FIG. 2 is a block diagram illustrating components of the cloud service system 102, according to some example embodiments. In various embodiments, the cloud service system 102 comprises components that obtain, store, and analyze data from the various data sources to determine which vertiports to use for a transportation service, which first-party vertiports to make available to the other flight networks 112, and whether additional capacity beyond the first-party vertiports is needed. To enable these operations, the cloud service system 102 comprises a device interface 202, a data storage 204, and an analysis engine 206 all configured to communicate with each other (e.g., via a bus, shared memory, or a switch). The cloud service system 102 may comprise other components (not shown) that are not pertinent to example embodiments. Furthermore, any one or more of the components (e.g., engines, interfaces, storage) described herein may be implemented using hardware (e.g., a processor of a machine) or a combination of hardware and software. Moreover, any two or more of these components may be combined into a single component, and the functions described herein for a single component may be subdivided among multiple components.

The device interface 202 is configured to exchange data with the other components in the network environment 100 including the vertiports 106, aerial vehicles 108, external data sources 110, and the other flight networks 112. For example, the device interface 202 receives real-time data from the vertiports 106 (e.g., data on pads being used or offline; data on the vertiport 106 being offline) and from the aerial vehicles 108 (e.g., telemetry data; fuel status). The device interface 202 also receives data on, for example, temporary flight restrictions (TFRs), air traffic configurations and reconfigurations, real-time weather, tracking of third-party aerial vehicles, energy pricing and capacity, and emergency medical services (EMS) requests.

Further still, the device interface 202 can exchange vertiport availability data with the other flight networks 112. In one embodiment, the device interface 202 can send a request for pad and final approach and take-off (FATO) availability of one or more of the other flight networks 112 and receive availability information in response (as part of the real-time data). The device interface 202 provides the information to the analysis engine 206 for use in determining whether to use a pad at the other flight networks 112. The analysis engine 206 may negotiated, via the device interface 202, for the use of the pad at the other flight network 112. For example, a pad at the other flight networks 112 may be used due to lack of capacity at the first-party vertiports 106 (e.g., pad or vertiport offline or at max capacity) or the cloud service system 102 may not have a first-party vertiport at the location of the pad.

Conversely, the device interface 202 can receive a request from the other flight networks 112 for availability of pads and FATO availability at the first-party vertiports 106. The analysis engine 206 can make a determination whether to make a pad at one of the vertiports 106 available to the requesting other flight network 112 and what operational cost to pass on. In an alternative embodiment, available capacity at vertiports 106 may be placed on an availability platform (not shown) coupled to the network 104. The availability platform allows flight networks (e.g., the cloud service system 102 and the other flight networks 112) to offer their extra capacity to any other flight network. Further still, the analysis engine 206 can weigh opportunity costs for operating a vertiport (or portion of the vertiport) that is made available to other flight networks versus simply closing (taking offline) the vertiport.

The data storage 204 stores historical data that is accessed by the analysis engine 206 for analysis. The historical data includes knowledge of past trips such as demand (e.g., based on time of day, time of week, and/or time of year, based on events), origins and destinations of past trips, distance of trips, noise impacts, weather, airspace usage, and energy spends of past trips. The historical data also includes information regarding which vertiports 106 have been offline/online based on region, time of day, time of week, time of year, which will indicate which vertiports 106 will most likely be offline/online in the future based on region or timing. For example, some vertiports may only be operational during certain times of the year. This can be due to weather conditions (e.g., closed during winter months) or demand patterns (e.g., operational only on days with a sporting event at a nearby location). Additionally, some vertiports may only be operational during certain times of the day. For example, there may be noise ordinances preventing a vertiport to be in user at night.

The analysis engine 206 is configured to optimize vertiport usage and to determine vertiport availability to offer to the other network systems 112. As such, the analysis engine 206 includes a routing optimizer 208 and a capacity optimizer 210. The analysis engine 206 uses data obtained in real time from the vertiports 106, aerial vehicles 108, and external data sources 110 along with historical data from the data storage 204 to perform its analysis.

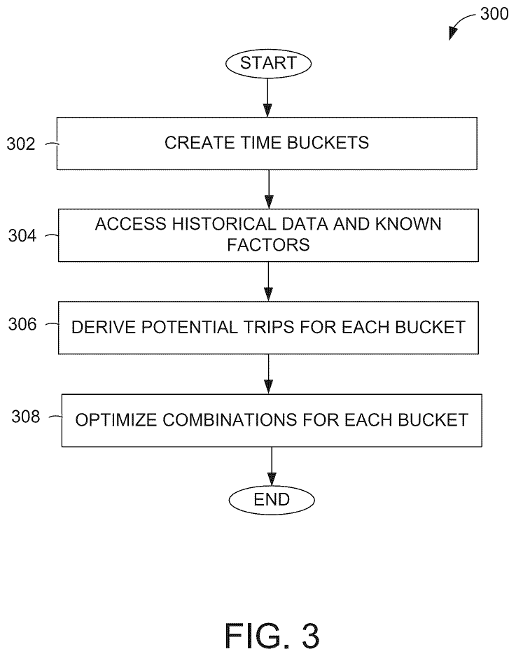

The routing optimizer 208 optimizes vertiport usage by simulating future flight operations and demand to generate a set of simulated flight operations (also referred to as a “flight operation set”) for one or more future time buckets. The simulation or simulated flight operation set can be created in advance of the time period of the actual flight operations (e.g., a week, a month, a quarter in advance) and used for planning and scheduling purposes. As the actual time period approaches (e.g., within a predetermined time of the time buckets of the simulated flight operation set), the routing optimizer 208 receives real-time data and analyzes the real-time data to determine if revisions need to be made to the simulated flight operation set. Any deviations or deltas to the simulated flight operation set is then used to retrain a component of the routing optimizer 208 such that future simulations may be more accurate in predicting flight operations. The operations of the routing optimizer 208 will be discussed in more detail in connection with FIG. 3 to FIG. 5 below.

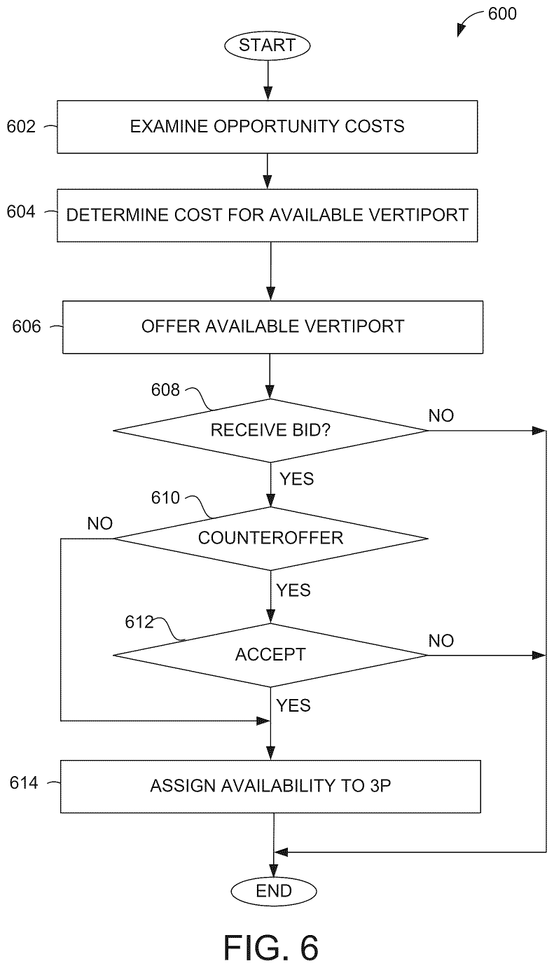

The capacity optimizer 210 manages the allocation of vertiport capacity (e.g., pads) at vertiports 106. The allocation includes determining vertiport capacity to offer to the other flight networks 112. The determination is based on opportunity costs including what the other flight networks 112 charge to use their facilities, what users are willing to pay in order to get them closer to their final destination (e.g., a destination that requires landing at a vertiport and taking ground transportation to reach), and whether using a pad of the other flight networks 112 saves costs versus using the first-party vertiport 106 (e.g., in terms of time or opportunity costs). In some cases, this is weighed against what the other flight networks 112 are willing to pay to use the first-party vertiports 106. Other factors include weather, noise (e.g., within a noise budget for a community), and energy. For example, if a vertiport is near its peak energy capacity, landing at this vertiport requires the aerial vehicle to charge or refuel at a slower rate than at a different vertiport thus effectively removing the aerial vehicle from operation for a longer period of time. The algorithms used to make these determinations range across the broad category of optimal decision making under uncertainty, and include Markov decision processes, dynamic programming, and gradient descent methods. The operations of the capacity optimizer 210 will be discussed in more detail in connection with FIG. 6 below.

FIG. 3 is a flowchart illustrating operations of a method 300 for generating a simulated flight operation set that simulates or predicts future flight operations, according to some example embodiments. Operations in the method 400 may be performed by components of the cloud service system 102 (e.g., the routing optimizer 208), using components described above with respect to FIG. 2. Accordingly, the method 300 is described by way of example with reference to the components on the cloud service system 102. However, it shall be appreciated that at least some of the operations of the method 300 may be deployed on various other hardware configurations. Therefore, the method 300 is not intended to be limited to the example embodiment of the cloud service system 102.

The simulated flight operation set may be created far in advance of the actual operation time. This is done in order to allow the cloud service system 102 to schedule flights and work around anticipated offline pads or vertiports (e.g., closed for maintenance or seasonality). In operation 302, the routing optimizer 208 creates time buckets for a particular future period of time (e.g., a day two weeks from now). In example embodiments, an operating day or week can be broken into sub-windows or time buckets with each representing a time slot. The time buckets can comprise a span of a few hours, a day, or any span of time desired for the simulated flight operation set and may be configurable by an operator of the cloud service system 102.

In operation 304, the routing optimizer 208 accesses historical data and known factors from the data storage 204. In some embodiments, the historical data and known factors correspond to the buckets of time that the simulated flight operation set is being generated for. For example, the historical data can correspond to data for the same time period over the last 3 years. The historical data and known factors can include knowledge about when vertiports typically go online or offline, historical demand patterns, historical weather and wind conditions, typical aerial vehicle availability and turnaround time, and/or past deltas from real-world operations (as will be discussed in more detail below).

In operation 306, the routing optimizer 208 derives potential trips for each time bucket. In example embodiments, the routing optimizer 208 tries to optimize the time buckets based on the historical data as well as the knowledge about the world (e.g., known factors discussed above). For each time bucket, an X number of trips are expected. Of those trips, the routing optimizer 208 knows the trips that the cloud service system 102 will likely want to satisfy (e.g., load factor constraints, time savings) and distances of those trips. Energy spends add to operating costs of each of these trips. Directness of routes based on airspace constraints is also considered. Local market effects are considered as well, including demographic likelihood to accept a flight, and ability and willingness to pay. Effectively, in each time bucket, the routing optimizer 208 computes all potential trips. In some embodiments, the routing optimizer 208 can learn from historical data which vertiports will most likely be online depending on time of year, location, weather conditions, or time of day. The routing optimizer 208 also learns from historical data a pattern of demand for specific vertiports. This knowledge is used in deriving the potential trips for each time bucket by using quantitative models of how the data interact and correlate. The models are then linked into a unified workflow that provides potential trips as a function of the numerous input factors.

In one embodiment, the routing optimizer 208 comprises a machine learning component that trains on the historical and known data. The output of the training is a trained model that future historical and real-time data can be applied to in order to generate the potential trips. For the routing optimizer 208, Markov decision processes are used to estimate the number of trips based on the current or predicted factors in combination with path optimization algorithms to determine the specific routes in accordance with one embodiment.

In operation 308, the routing optimizer 208 optimizes combinations of trips for each time bucket. In example embodiments, the routing optimizer 208 iterates amongst the potential trips to determine what is the best combination of trips (including deadheads) that satisfies the users on the network, minimizes costs, maximizes profit within the boundaries of all constraints, satisfy constraints around ground staff/crew duty rest time regulations, and/or satisfy noise ordinances at the vertiport. The algorithm works by constraining the search space to only routes that have been pre-validated, and then uses a genetic search method to find the “fittest” combination of routes. The result is a set of flight operations that can be used to inform which vertiports to use in future transportation scenarios.

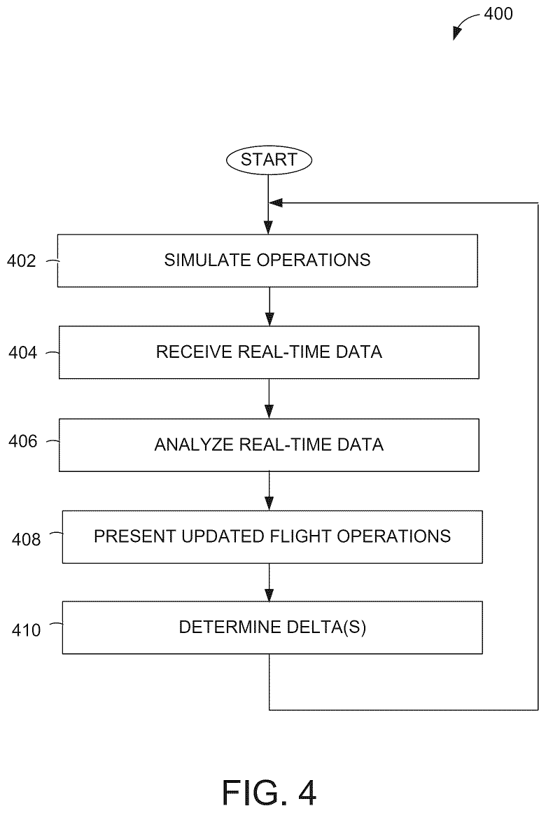

FIG. 4 is a flowchart illustrating operations of a method 400 for optimizing periodic vertiport usage for transportation services, according to some example embodiments. Operations in the method 400 may be performed by the cloud service system 102, using components described above with respect to FIG. 2. Accordingly, the method 400 is described by way of example with reference to the cloud service system 102. However, it shall be appreciated that at least some of the operations of the method 400 may be deployed on various other hardware configurations or be performed by similar components residing elsewhere in the network environment 100. Therefore, the method 400 is not intended to be limited to the cloud service system 102.

In operation 402, the routing optimizer 208 simulates flight operations. Operation 402 encompasses the operations of the method 300 discussed in connection with FIG. 3 above. As such, the flight operation set outputted in operation 308 includes the simulated flight operations. In various embodiments, the simulated flight operation set is determined in advance of actual flight operations. For example, the flight operation set may include simulate flight operations for the next week, month, quarter, or any other period of time. This allows the cloud service system 102 to plan for capacity as well as bringing vertiports (or pads at vertiports) online or offline as need. Further still, the simulated flight operation set allows the cloud service system 102 to anticipate availability or lack of availability at their first-party vertiports 106 and plan accordingly (e.g., offer availability to other flight networks 112 or obtain capacity from the other flight networks 112).

For example, based on the historical trend of users for a particular vertiport, the simulated flight operation set can indicate that in the morning for a particular week, there is not much room to add an additional aerial vehicle, but in the afternoon there may be capacity to add an additional aerial vehicle between 2 pm and 4 pm. Therefore, capacity can be increased in the afternoon if demand should suddenly change.

In operation 404, the cloud service system 102 receives real-time data within a predetermined time (e.g., within 24 hours) prior to the corresponding time buckets for which the simulated flight operation set under consideration was generated. The real-time data can include current demand for transportation service (e.g., transportation service requests that indicate an origin and destination along with a number of passengers, anticipated weight or number of baggage, and desired time of arrival), or any other data that can affect flight operations (e.g., event being canceled near a vertiport). The real-time data also can include any flight restrictions (TFRs) and air traffic reconfigurations (e.g., for airports/airspace near the vertiports 106) in the near future, real-time weather (or weather forecast for the near future) along and around skylanes (e.g., flight paths or routes between vertiports whereby each skylane starts and ends at a vertiport), prevailing wind directions and conditions, and tracking information for other aerial vehicles in and around the skylanes. For example, air traffic from an airport that a vertiport is close to can affect routes and prevent takeoffs and landings landing at the vertiport. If an air traffic path changes or is reconfigured, it can affect, for some period of time, the use of that vertiport until that reconfiguration is completed. For instance, the vertiport may need to go completely offline or reduce takeoffs and landings during that reconfiguration time.

The receiving of real-time data can be based on monitoring and tracking performed by the cloud service system 102. For example, the cloud service system can monitor the status of all of the first-party vertiports 106 and track their aerial vehicles 108. The cloud service system 102 also tracks the transportation service requests received from users which provides an indication of real-time demand.

Real-time data further includes status from the vertiports 106 and the aerial vehicles 108. Vertiport status includes anticipated hours of operations, data on pads that will be online and available, pads that will be offline or unavailable (e.g., down for maintenance), and/or anticipated changes in status of each pad. The anticipated change in status is based on planned aerial vehicles that will be landing or taking off within a predetermined period of time (e.g., in the next few time buckets) thus changing status of the pads. Status can also include temporary changes that affect the availability of pads or the vertiports. For example, a TFR may temporarily close a vertiport for a period of time. Conversely, a temporary vertiport may come online for emergency use or for a special event.

Status of aerial vehicles 108 includes pre-flight, inflight, and post-flight data for each aerial vehicle 108. Inflight data may include telemetry and energy level data. The telemetry data provides an indication of where each aerial vehicle 108 is located. The energy level data can provide an indication of how much energy (e.g., charging or refueling) each aerial vehicle 108 may need at its next vertiport which affects how quickly the aerial vehicle 108 can be assigned to a next transportation service request and how long a pad will be unavailable while the aerial vehicle 108 is refueling on it. Aerial vehicle data can also include maintenance logs for aerial vehicles 108 (e.g., when aerial vehicles 108 need to get maintenance at certain pads/vertiports) which may affect capacity (e.g., aerial vehicle availability and/or pad availability).

In some embodiments, the real-time data also includes energy provider data. Energy providers may be third-party entities that provide the energy (e.g., electricity) for the aerial vehicles. The energy provider data includes pricing and energy capacity at each vertiport. The pricing affects the opportunity costs while the energy capacity affects availability of aerial vehicles. For example, if a vertiport is near peak energy capacity for providing energy, it may take longer to refuel/recharge an aerial vehicle landing at that vertiport and affect the turnaround time for the aerial vehicle. Similarly, ambient air temperature and precipitation conditions can affect the rate at which aircraft recharge and therefore can delay flight operations.

In operation 406, the routing optimizer 208 analyzes the real-time data to determine if the simulated flight operations (i.e., the simulated flight operation set) that was previously derived for the upcoming time buckets needs to be adjusted. If based on the combination of real-time data, the simulated flight operation set does need to be adjusted, the routing optimizer 208 makes the adjustments to the simulated flight operation set.

Continuing with the example from above, the flight operations that were planned, for example, a week ago (e.g., the simulated flight operation set) are for tomorrow. However, because of weather conditions (i.e., real-time data) the past few days and similarly anticipated weather for tomorrow, the morning flights are being pushed into the afternoon. As such, the capacity to add the additional aerial vehicle between 2 pm and 4 pm is no longer there. Additionally, the morning flights may be rescheduled to later times.

In a different example, the weather forecast can indicate that the next two days will be hot. As such, demand will be higher for flights to the coast (e.g., to go to the beach). Thus, the weather forecast (i.e., real-time data) can cause a deviation from the simulated flight operation set whereby more flights may be added to a vertiport (or a temporary vertiport brought online) near the coast. Conversely, if a sudden cold front is moving in, demand will plummet for flights to the coast. Here, scheduled flights to a vertiport near the coast may be reduced or canceled or the vertiport shut down (e.g., the optimization algorithm will be greatly penalized if it uses routes near the coast since it is predicted there won't be much demand).

A change in an event can also cause a deviation from the simulated flight operation set. For instance, if a sporting event is canceled, then the anticipated demand for flights to vertiport(s) near the event will plummet. Conversely is an additional concert is added at the last minute, then demand will likely increase to vertiports near the concert location. As such, the real-time data can include data from venues where events occur or social media (that provides notice of events).

In example embodiments, the addition or removal of one or more pads or vertiports (or anticipation of the addition or removal of a pad or vertiport in the upcoming time buckets), whether they are first-party or third-party, along with a multitude of other factors will affect the routing for the transportation service. Another consideration is weather. For instance, a first-party vertiports may not be available (e.g., goes offline) because of a weather condition (e.g., thunderstorm). In some cases, the first-party vertiport may be partially available in case of a malfunctioning recharging infrastructure. Thus, one or more vertiports going offline can also cause a deviation from the simulated set of flight operation.

A determination of which vertiport to use is also based on opportunity costs. The opportunity costs factor in, for example, what using a third-party vertiport may cost, what each user is willing to pay to arrive closer to their final destination in order to save time, and will using a third-party vertiport reduce a length of a flight and save money versus using a first-party vertiport that may be a longer flight or farther from the final destination. In some cases, the routing optimizer 208 and/or the capacity optimizer 210 may also consider what other flight networks 112 will pay for use of first-party vertiports 106. These operations will be discussed in more detail in connection with FIG. 6 below.

In some embodiments, there may be operational requirements that a vertiport have a certain number of pads available in case of an emergency, which will affect whether the routing optimizer 208 can select that vertiport for a transportation service. Additionally, if a pad is under maintenance, it also affects whether the routing optimizer 208 can select that vertiport for the transportation service and can cause a deviation from the simulated flight operations.

The routing optimizer 208 also considers noise and energy. For instance, if a vertiport is near its peak energy capacity and if an aerial vehicle were to land there, the aerial vehicle may receive a charge or refuel at a slower speed versus landing at a different, nearby vertiport. Noise budget is considered in terms of community impact. Each community may have a particular noise budget and as usage of the vertiport approaches a cap on the noise budget, further flights may need to be reduced to that vertiport.

In operation 408, the routing optimizer 208 presents, via the device interface, the flight operations for “current” time buckets (e.g., this afternoon, tomorrow). The flight operations for the current time buckets may be the same as the simulate flight operations if the real-time data does not indicate any deviations from patterns of the historical data. However, if the real-time data causes a deviation to the simulated flight operations, the deviations (or updated flight operations) are presented to, for example, an operator or agent associated with the cloud service system 102.

In some embodiments, flight option(s) determined from the updated flight operations may be presented to a user that has requested transportation service. These users select from a plurality of different flight options (e.g., that may have different pricing) or reject any presented flight options and cancel their request for transportation service. In some cases, the flight options may be presented to a requesting user that had previously booked their transportation service, but their original flight option (based on the simulated operations) is affected by the real-time data (e.g., original flight option canceled or scheduled for a different time).

In operation 410, the routing optimizer 208 determines deltas (e.g., differences) between the simulated flight operations (and corresponding factors) and the results from the real-world analysis (e.g., actual flight options, availability and capacity) performed in operation 406. In example embodiments, the deltas are fed back into operation 402 (and thus operation 302 of FIG. 3) and the simulation revised. It is noted that the simulation of flight operations is continuous as is the analysis of the real-time data. This allows for up-to-date modeling and scheduling of flight operations. For instance, the analysis (operation 406) can be triggered after each instance of new real-time data is received or certain types of real-time data is received (e.g., temporary flight restrictions (TFRs), air traffic configurations and reconfigurations).

Thus, when vertiports come online or offline in the real world, it has a significant impact on the optimization and subsequently all of the evaluations of the constraints. A network planning function of the routing optimizer 208 provides an iterative process using the constraints to optimize vertiport usage at different times throughout the day. Over time, there will likely be patterns in the way that the vertiports come online and go offline. The routing optimizer 208 (e.g., the machine learning component) uses the historical status of when a particular pad or vertiport was available to populate and update the conditional probability distributions in a Bayes Net using input variables like time of day, day of week, and weather conditions. The Bayes Net model predicts the likelihood of when the vertiport may come online. This narrows the uncertainty band on decisions that the routing optimizer 208 may need to make.

The routing optimizer 208 makes adjustments to the time buckets and between the time buckets (e.g., operation 302) based on the deltas and real-time data and learns from real-time operations. In particular, the routing optimizer 208 determines what is changing in the real world, models it, and re-evaluates based on true data (e.g., real-time data) to derive what the future may look like. Effectively, the routing optimizer 208 comprises an optimization function that runs persistently in parallel with real-time operations and ranks the best options. Over time, the delta should minimize.

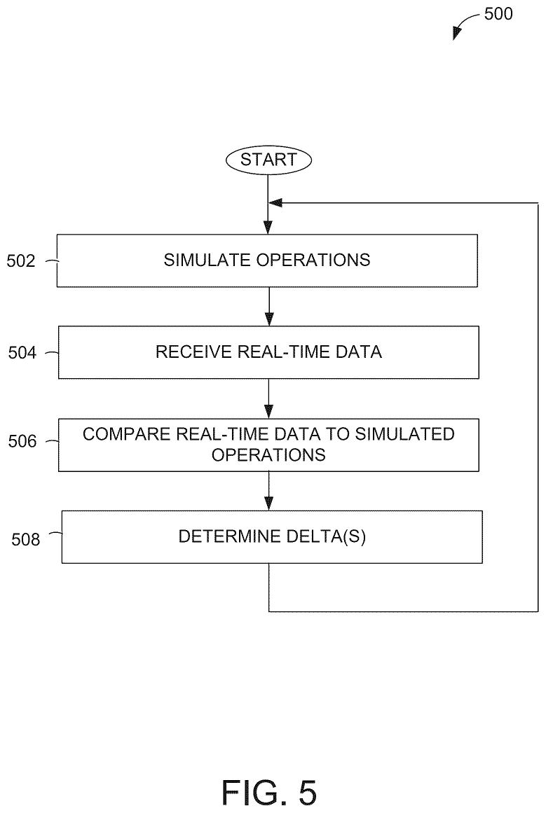

FIG. 5 is a flowchart illustrating operations of a further method 500 for optimizing periodic vertiport usage for transportation services, according to some example embodiments. Operations in the method 500 may be performed by the cloud service system 102, using components described above with respect to FIG. 2. Accordingly, the method 500 is described by way of example with reference to the cloud service system 102. However, it shall be appreciated that at least some of the operations of the method 500 may be deployed on various other hardware configurations or be performed by similar components residing elsewhere in the network environment 100. Therefore, the method 500 is not intended to be limited to the cloud service system 102. The method 500, similar to the method 400, simulates operations and receives real-time data where the real-time data is analyzed and used to compare with the simulated operations. However, the real-time data in the method 500 comprises data indicating what actually happened with respect to flight operations. Thus, in various embodiments both method 400 and method 500 can be used together to analyze immediately upcoming flight operation sets and past flight operations sets.

In operation 502, the routing optimizer 208 simulates flight operations. Operation 502 encompasses the operations of the method 300 discussed in connection with FIG. 3 above. The flight operation set outputted in operation 308 includes the simulated flight operations, which is determined in advance of actual flight operations. For example, the simulated flight operation set may include simulated flight operations for the next week, month, quarter, or any other period of time, which allows the cloud service system 102 to plan for capacity. Further still, the simulated flight operation set allows the cloud service system 102 to anticipate availability or lack of availability at their first-party vertiports 106 and plan accordingly (e.g., offer availability to other flight networks 112 or obtain capacity from the other flight networks 112).

In operation 504, the cloud service system 102 receives real-time data. In this embodiment, the real-time data comprises the actual flight operations that occurred and corresponding factors that potentially have impact on the flight operations. For example, the corresponding factors can include the actual demand for transportation service (e.g., number of passengers), actual weather conditions, any flight restrictions (TFRs) and air traffic reconfigurations (e.g., for airports/airspace near the vertiports 106) that occurred, and status of the vertiports 106 and the aerial vehicles 108. Vertiport status includes the actual hours of operations, data on pads that were online and available, pads that were offline or unavailable, and/or changes in status of each pad (e.g., how long each pad was in use throughout the time period). In some embodiments, the real-time data also includes energy provider data such as pricing and energy capacity and usage at each vertiport.

In operation 506, the real-time data that indicates what actually happened is compared to the simulated flight operations (i.e., prediction of what should happen) from operation 502 including comparing the corresponding factors. The comparison will identify, in operation 508) differences or deltas between what actually happened versus what was predicted to happen. These deltas are then provided back to operation 502 (or operation 302 of FIG. 3) to improve the simulation.

FIG. 6 is a flowchart illustrating operations of a method 600 for determining and exchanging availability data of vertiports, according to some example embodiments. Operations in the method 600 may be performed by components of the cloud service system 102, using components described above with respect to FIG. 2. Accordingly, the method 600 is described by way of example with reference to the components on the cloud service system 102. However, it shall be appreciated that at least some of the operations of the method 600 may be deployed on various other hardware configurations. Therefore, the method 600 is not intended to be limited to the example embodiment of the cloud service system 102.

In example embodiments, the cloud service system 102 determines who is allowed to use the first-party vertiports 106 (or pads at these vertiports) and which third-party vertiports (e.g., of the other flight networks 112) the cloud service system 102 has access or wants access to use. In some cases, the cloud service system 102 must allow certain services to use the first-party vertiports 106, such as for EMS. Additionally, the cloud service system 102 factors in limits on the number of takeoffs and landings that can be performed at vertiports and limits on hours of operation (e.g., curfews).

In operation 602, the capacity optimizer 210 examines opportunity costs. In some embodiments, the opportunity costs are based on the simulation or simulated flight operation set generated by the routing optimizer 208 (e.g., method 300). In some embodiments, the opportunity costs are based on usage throughout the year and how many flights the cloud service system 102 expects. This results in an original estimate of the opportunity costs. In some embodiments, the capacity optimizer 210 may use a feedback loop by aggregating the actual costs throughout a day and projecting that out. Other costs, such as energy are reasonably known.

There may also be operational risk or safety aspects to factor into the opportunity costs. In a case where several of the vertiports 106 go offline at the same time, there may be a risk to operate the aerial vehicles 108. In this case, it may make more sense to allow the other flight networks 112 to use the first-party vertiports 106. Further still, there may be first-party vertiports 106 in locations where the cloud service system 102 does not offer transportation services (or has limited service). Here too, the cloud service system 102 can offer vertiport availability (e.g., provide in an open market) to the other flight networks 112.

In example embodiments, the capacity optimizer 210 works with the routing optimizer 208 to project demand based on predictions (e.g. the simulation of flight operations) and determine what the cloud service system 102 actually sees in transportation service requests and bookings along with what users are willing to pay for their transportation service. All this is used to calculate the opportunity cost in terms of what revenues can be generated by having pads at the first-party vertiports 106 available to the other flight networks 112. Accordingly, if it is a low transportation service request day, this affects the opportunity costs and the capacity optimizer 210 is more willing to offer capacity to the other flight networks 112. Statistics on risk and safety can be used to build the conditional probability tables of a Bayes Net, which subsequently provide predictions of the risk of certain undesirable outcomes. These risks can be used by machine learning algorithms (e.g. Markov decision processes) to determine the best course of action to take given current circumstances.

As discussed above, selecting which vertiport to use for flight operations is based on opportunity costs. The opportunity costs factor in, for example, what using a third-party vertiport may cost, what each user is willing to pay to arrive closer to their final destination in order to save time, and will using a third-party vertiport reduce a length of a flight and save money/fuel versus using a first-party vertiport that may be a longer flight or farther from the final destination. In some cases, the capacity optimizer 210 may also consider what other flight networks 112 will pay for use of first-party vertiports 106.

Noise can also affect the opportunity cost. For example, if a user is closer to a third-party vertiport, but the cloud service system 102 has to pay a higher landing fee to use the third-party vertiport, the capacity optimizer 210 needs to decide how much of the cost to pass on to the user. A further consideration is the distance of each trip and energy spends add to operating costs. Thus, the capacity optimizer 210 considers directness of routes based on airspace constraints (e.g., flight restrictions, reconfigurations) along with a time users want to arrive at their destinations. All of these factors can be constantly considered in real time and, in some cases, with each transportation service request (e.g., will be on a flight-by-flight basis) and can have the potential to change mid-flight.

In some embodiments, the capacity optimizer 210 comprises a machine learning component that trains on the various factors that affect opportunity costs and outputs the opportunity costs. The complex set of data that is used to generate opportunity cost can be accounted for according to a variety of statistical or empirical metrics. These metrics may be collected during normal operations to form the training data set. A support vector machine (SVM) can then partition the data into a finite set of opportunity cost magnitudes. Real-time metrics are computed and located within a partition, allowing for rapid understanding of the opportunity costs of particular decisions. Over time trends will be observed and highlight what decisions are the most often taken and how they most often affect positively and negatively the opportunity costs.

In operation 604, the capacity optimizer 210 determines cost for pads at the vertiports 106 that the cloud service system 102 will offer to the third-party networks 112. In example embodiments, the capacity optimizer 210 examines opportunity costs to the cloud service system 102 and what other options in the market are. In a base case, the cloud service system 102 is the primary user of the first-party vertiports 106. Then, the cloud service system 102 provides available capacity to other flight networks 112 based on opportunity costs (e.g., what they will pay vs. what missed revenues may occur). In some cases, there may be a weighting factor applied (e.g., preference for some third-party entities over others). The cost is also weighted by the historical likelihood of third-party entities to pay for pad or other infrastructure usage, and the amount they have been willing to pay in relevant situations. These data can be encoded into Bayes Nets which, combined with consumer choice models, may be trained to predict the pad price that maximizes the return to the first-party operator. All of this is considered by the capacity optimizer 210 in determining cost at which to offer the available capacity.

In operation 606, the capacity optimizer 210 may offer the available capacity to the other flight networks 112. In one embodiment, there may be a bidding type system or platform where the available capacity is offered. In an alternative embodiment, the bidding type system or platform may allow the other flight networks 112 to provide offers (e.g., requests) for available capacity from which the capacity optimizer 210 can select. The bids or offers may affect what prices are charged (e.g., higher demand will result in a higher cost). It is noted that in some cases, it may actually be better to just take the vertiport 106 offline rather than making it available to the other flight networks 112. In those cases, the method 600 ends after operation 604.

In operation 608, the capacity optimizer 210 determines whether a bid is received in response to an offering of the capacity. If a bid is received, the capacity optimizer 210 determines if the bid is a counteroffer in operation 610. If the bid is not a counteroffer, then the bid can be an acceptance of the offered capacity at a cost set by the capacity optimizer 210 in operation 604. In this case, the available capacity (e.g., a pad at a particular vertiport) is assigned to the third-party providing the bid in operation 614.

Alternatively, if a counteroffer is made, then in operations 612, the capacity optimizer 210 determines whether to accept the counteroffer. In example embodiments, the capacity optimizer 210 will weigh the opportunity costs to determine whether to accept the counteroffer. If the counteroffer is accepted, then the available capacity (e.g., a pad at a particular vertiport) is assigned to the third-party providing the bid in operation 614.

While example embodiments have been discussed with respect to vertiports, alternative embodiment can be directed to any type of skyport (e.g., airports, airfield, helicopter pad).

In further embodiments, inputs to a vertiport optimization service provided by the cloud service system 102 include a fleet schedule for an operator with operations assigned to specific vertiports, demand profiles for new riders, demand profiles for other potential operators at the vertiport, weather conditions and predictions, noise ordinances, services offered at the vertiports, and other factors. The vertiport optimization service then estimates vertiport availability for a given timeframe of operations and decides whether or not to offer an aerial ridesharing service from/to that vertiport to riders during that timeframe.

The vertiport optimization service allows operators to better distribute their fleet amongst vertiports in order to offer the best aerial ridesharing options to riders. For an operator that controls the vertiports, this vertiport optimization service allows the operator using the service to allocate pads and/or time periods at which it is economically preferable to lease the vertiport to third-party operators. For an operator that does not control the vertiports, the vertiport optimization service allows them to determine which vertiport infrastructure is available so they can optimize their fleet operations. The vertiport optimization service determines if vertiports have sufficient capacity to accept additional flight operations. Furthermore, with the vertiport optimization service, operators can also understand the costs of using the vertiports and associated infrastructure to make an informed decision whether or not to offer a flight to a rider.

Given estimated trip demand profiles, an operator, regardless of controlling the vertiports or not, can use the vertiport optimization service to establish its network of flights and adjust its flight schedule over time between vertiports based on historical usage, availability, and associated costs.

FIG. 7 illustrates components of a machine 700, according to some example embodiments, that is able to read instructions from a machine-storage medium (e.g., a machine-readable storage device, a non-transitory machine-readable storage medium, a computer-readable storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIGS. 3-6. In one embodiment, the instructions 724 can transform the general, non-programmed machine 700 into a particular machine (e.g., specially configured machine) programmed to carry out the described and illustrated functions in the manner described.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-readable storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-readable media (e.g., tangible and non-transitory machine-readable media). The instructions 724 may be transmitted or received over a network 726 via the network interface device 720.

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

### Examples

Example 1 is a method for providing periodic vertiport usage and capacity data exchange. The method comprises generating, based on historical data by one or more hardware processors of a cloud service system, a flight operation set that comprises a simulation of flight operations for one or more time buckets in the future, the simulation of flight operations include transportation services between vertiports; receiving, within a predetermined time period of the one or more time buckets, real-time data including weather forecasts and actual demand for transportation services; analyzing the real-time data to determine any deviations from the flight operation set for the one or more time buckets; and causing presentation of the flight operation set including any deviations.

In example 2, the subject matter of example 1 can optionally include wherein the generating the flight operation set comprises creating the one or more time buckets that each represents a time slot during an operating period; accessing historical data and known factors, at least some of the historical data and known factors corresponding to the operating period; deriving potential trips for each time bucket; and optimizing combinations of potential trips for each time bucket.

In example 3, the subject matter of any of examples 1-2 can optionally include examining opportunity costs, the opportunity costs being based on the flight operation set; based on the opportunity costs, determining costs for available capacity; and offering the available capacity on a platform to other flight networks, the available capacity comprising a pad at a vertiport.

In example 4, the subject matter of any of examples 1-3 can optionally include receiving acceptance of the available capacity from an entity of the other flight networks; and assigning the available capacity to the entity.

In example 5, the subject matter of any of examples 1-4 can optionally include receiving a counteroffer for the available capacity from an entity of the other flight networks; accepting the counteroffer; and assigning the available capacity to the entity.

In example 6, the subject matter of any of examples 1-5 can optionally include providing the deviations as deltas to train a machine learning component of the cloud service system that generates the flight operation set.

In example 7, the subject matter of any of examples 1-6 can optionally include providing the deviations as historical data used to refine generating of future flight operation sets.

In example 8, the subject matter of any of examples 1-7 can optionally include wherein the generating, receiving, and analyzing continuously occurs for different time buckets.

In example 9, the subject matter of any of examples 1-8 can optionally include determining based on the flight operation set that further capacity is needed during the one or more time buckets; and requesting additional capacity from other flight networks.

Example 10 is a system to provide periodic vertiport usage and capacity data exchange. The system includes one or more processors and a memory storing instructions that, when executed by the one or more hardware processors, causes the one or more hardware processors to perform operations comprising based on historical data, generating, by an analysis component of a cloud service system, a flight operation set that comprises a simulation of flight operations for one or more time buckets in the future, the simulation of flight operations include transportation services between vertiports; receiving, after the one or more time buckets has passed, real-time data indicating actual flight operations, the real-time data including factors that potentially have impact on the flight operations; comparing, by one or more hardware processors of the cloud service system, the real-time data to the flight operation set to identify deltas; and providing the deltas as feedback to the analysis component, the deltas being used to refine the generating of future flight operation sets.

In example 11, the subject matter of example 10 can optionally include wherein the factors comprise actual demand for the transportation service, weather conditions, and status of vertiports and aerial vehicles during the one or more time buckets.

In example 12, the subject matter of any of examples 10-11 can optionally include wherein the generating the flight operation set comprises creating the one or more time buckets that each represents a time slot during an operating period; accessing historical data and known factors, at least some of the historical data and known factors corresponding to the operating period; deriving potential trips for each time bucket; and optimizing combinations of potential trips for each time bucket.

In example 13, the subject matter of any of examples 10-12 can optionally include examining opportunity costs, the opportunity costs being based on the flight operation set; based on the opportunity costs, determining costs for available capacity; and offering the available capacity on a platform to other flight networks, the available capacity comprising a pad at a vertiport.

In example 14, the subject matter of any of examples 10-13 can optionally include receiving acceptance of the available capacity from an entity of the other flight networks; and assigning the available capacity to the entity.

In example 15, the subject matter of any of examples 10-14 can optionally include receiving a counteroffer for the available capacity from an entity of the other flight networks; accepting the counteroffer; and assigning the available capacity to the entity.

In example 16, the subject matter of any of examples 10-15 can optionally include wherein providing the deltas as feedback to the analysis component comprises providing the delta as historical data used to refine the generating of the future flight operation sets.

In example 17 the subject matter of any of examples 10-16 can optionally include wherein the generating, receiving, and analyzing continuously occurs for different time buckets.

In example 18, the subject matter of any of examples 10-17 can optionally include determining based on the flight operation set that further capacity is needed during the one or more time buckets; and requesting additional capacity from other flight networks.

Example 19 is a machine-storage medium storing instructions for providing periodic vertiport usage and capacity data exchange. The machine-storage medium configures one or more processors to perform operations comprising generating, based on historical data, a flight operation set that comprises a simulation of flight operations for one or more time buckets in the future, the simulation of flight operations include transportation services between vertiports; receiving, within a predetermined time period of the one or more time buckets, real-time data including weather forecasts and actual demand for transportation services; analyzing the real-time data to determine any deviations from the flight operation set for the one or more time buckets; and causing presentation of the flight operation set including any deviations.

In example 20, the subject matter of example 19 can optionally include wherein the operations further comprise examining opportunity costs, the opportunity costs being based on the flight operation set; based on the opportunity costs, determining costs for available capacity; and offering the available capacity on a platform to other flight networks, the available capacity comprising a pad at a vertiport.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A computer-implemented method for flight network telecommunications, the method comprising:
accessing, by a first flight network computing system, data indicative of a plurality of vertiports that are online with a first flight network, each of the vertiports comprising infrastructure available for take-off and landing of VTOL aircraft that provide transportation for the first flight network;
accessing, by the first flight network computing system, real-time data indicative of a constraint affecting the operation of the VTOL aircraft of the first flight network;
based on the real-time data, performing, by the first flight network computing system, one or more simulations that simulate the routing and transportation of the VTOL aircraft using at least a portion of the plurality of vertiports;
based on the one or more simulations, computing, by the first flight network computing system, a simulation output, the simulation output being indicative of a deficit in vertiport capacity for the first flight network;
based on the simulation output, computing, by the first flight network computing system using an API, a data exchange request for a second flight network, the data exchange request comprising a request for data associated with an additional vertiport of the second flight network;
transmitting, by the first flight network computing system, the data exchange request to a second flight network computing system of the second flight network; and
communicatively coupling, over a network, the first flight network computing system to a computing system that is associated with the additional vertiport to bring the additional vertiport online with the first flight network.

2. The computer-implemented method of claim 1, further comprising: routing, by the first flight network computing system, a VTOL aircraft based on the additional vertiport.

3. The computer-implemented method of claim 1, wherein performing the one or more simulations comprises:
performing, by the first flight network computing system, a first simulation that simulates the routing and transportation of the VTOL aircraft using the plurality of vertiports;
based on the first simulation, computing, by the first flight network computing system, an initial simulation output indicative of one or more flights between at least a subset of the plurality of vertiports;
computing, by the first flight network computing system, simulation feedback data based on the real-time data and the initial simulation output; and
based on the simulation feedback data, performing, by the first flight network computing system, a second simulation that simulates the routing and transportation of the VTOL aircraft using the plurality of vertiports and a constraint affecting the operation of the VTOL aircraft of the first flight network, the second simulation being a refined version of the first simulation based on the simulation feedback data.

4. The computer-implemented method of claim 3, further comprising:
computing, by the first flight network computing system, the simulation output based on the second simulation.

5. The computer-implemented method of claim 1, wherein the constraint affecting the operation of the VTOL aircraft of the first flight network comprises at least one of: (i) take-off or landing pad availability; (ii) energy usage at a respective vertiport; (iii) energy capacity at a respective vertiport; (iv) a temporary flight restriction; (v) an air traffic configuration or reconfiguration; (vi) a weather constraint; (vii) an emergency request; (viii) a change associated with a skylane; or (ix) a noise budget.

6. The computer-implemented method of claim 1, wherein the simulation output comprises an updated flight operations set.

7. The computer-implemented method of claim 1, wherein the real-time data comprises data associated with the aircraft.

8. The computer-implemented method of claim 7, wherein the data associated with the aircraft is indicative of a battery level of an aircraft.

9. The computer-implemented method of claim 8, further comprising: computing, based on the data associated with the aircraft, a prediction when the aircraft will need access to a pad for charging at a vertiport.

10. The computer-implemented method of claim 8, further comprising: computing, based on the data associated with the aircraft, a predicted amount of charge that the aircraft will need to receive at a vertiport.

11. A computing system comprising:
one or more processors; and
one or more computer storage media storing instructions that are executable by the one or more processors to perform operations, the operations comprising:
accessing data indicative of a plurality of vertiports that are online with a first flight network, each of the vertiports comprising infrastructure available for take-off and landing of VTOL aircraft that provide transportation for the first flight network;
accessing real-time data indicative of a constraint affecting the operation of the VTOL aircraft of the first flight network;
based on the real-time data, performing one or more simulations that simulate the routing and transportation of the VTOL aircraft using at least a portion of the plurality of vertiports;
based on the one or more simulations, computing a simulation output, the simulation output being indicative of a deficit in vertiport capacity for the first flight network;
based on the simulation output, computing, using an API, a data exchange request for a second flight network, the data exchange request comprising a request for data associated with an additional vertiport of the second flight network;
transmitting the data exchange request to a flight network computing system of the second flight network; and
communicatively coupling, over a network, to a computing system that is associated with the additional vertiport to bring the additional vertiport online with the first flight network.

12. The computing system of claim 11, wherein the operations further comprise: routing a VTOL aircraft based on the additional vertiport.

13. The computing system of claim 11, wherein performing the one or more simulations comprises:
performing a first simulation that simulates the routing and transportation of the VTOL aircraft using the plurality of vertiports;
based on the first simulation, computing an initial simulation output indicative of one or more flights between at least a subset of the plurality of vertiports;
computing simulation feedback data based on the real-time data and the initial simulation output; and
based on the simulation feedback data, performing a second simulation that simulates the routing and transportation of the VTOL aircraft using the plurality of vertiports and a constraint affecting the operation of the VTOL aircraft of the first flight network, the second simulation being a refined version of the first simulation based on the simulation feedback data.

14. The computing system of claim 13, wherein the operations further comprise: computing the simulation output based on the second simulation.

15. The computing system of claim 11, wherein the constraint affecting the operation of the VTOL aircraft of the first flight network comprises at least one of: (i) take-off or landing pad availability; (ii) energy usage at a respective vertiport; (iii) energy capacity at a respective vertiport; (iv) a temporary flight restriction; (v) an air traffic configuration or reconfiguration; (vi) a weather constraint; (vii) an emergency request; (viii) a change associated with a skylane; or (ix) a noise budget.

16. The computing system of claim 11, wherein the real-time data comprises data indicative of battery levels of the respective aircraft.

17. The computing system of claim 11, wherein performing the one or more simulations comprises: computing, based on the data indicative of battery levels of the respective aircraft, a prediction as to when the respective aircraft will need access to a vertiport for charging and a predicted amount of charge that the respective aircraft will need to receive at the vertiport.

18. One or more tangible and non-transitory computer storage media comprising instructions that are executable by one or more processors to perform operations, the operations comprising:
accessing data indicative of a plurality of vertiports that are online with a first flight network, each of the vertiports comprising infrastructure available for take-off and landing of VTOL aircraft that provide transportation for the first flight network;
accessing real-time data indicative of a constraint affecting the operation of the VTOL aircraft of the first flight network;
based on the real-time data, performing one or more simulations that simulate the routing and transportation of the VTOL aircraft using at least a portion of the plurality of vertiports;
based on the one or more simulations, computing a simulation output, the simulation output being indicative of a deficit in vertiport capacity for the first flight network;
based on the simulation output, computing, using an API, a data exchange request for a second flight network, the data exchange request comprising a request for data associated with an additional vertiport of the second flight network;
transmitting the data exchange request to a flight network computing system of the second flight network; and
communicatively coupling, over a network, to a computing system that is associated with the additional vertiport to bring the additional vertiport online with the first flight network.

19. The one or more tangible and non-transitory computer storage media of claim 18, wherein the operations further comprise:
routing a VTOL aircraft based on the additional vertiport.

20. The one or more tangible and non-transitory computer storage media of claim 18, wherein performing the one or more simulations comprises:
performing a first simulation that simulates the routing and transportation of the VTOL aircraft using the plurality of vertiports;
based on the first simulation, computing an initial simulation output indicative of one or more flights between at least a subset of the plurality of vertiports;
computing simulation feedback data based on the real-time data and the initial simulation output; and
based on the simulation feedback data, performing a second simulation that simulates the routing and transportation of the VTOL aircraft using the plurality of vertiports and a constraint affecting the operation of the VTOL aircraft of the first flight network, the second simulation being a refined version of the first simulation based on the simulation feedback data.
